(19) United States
(12) Patent Application Publication
(10) Pub. No.: US 2006/0000809 A1
(43) Pub. Date: Jan. 5, 2006

(54) Glass substrate for information recording media and its fabricating method

(75) Inventor: Seiji Matsumoto, Osaka-shi (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: HOYA COROPORATION, Tokyo (JP)

(21) Appl. No.: 10/526,518

(22) PCT Filed: Dec. 25, 2003
(86) PCT No.: PCT/JP03/16673

§ 371 Date: Mar. 3, 2005

(30) Foreign Application Priority Data
Dec. 26, 2002 (JP) 2002-378757

(51) Int. Cl. B44C 1/22

(52) U.S. Cl. 216/91

(57) ABSTRACT

A method for fabricating a glass substrate for information recording media. A uniform texture can be formed in a major surface of the glass substrate without degrading the smoothness of the major surface. The method comprises a step of forming a texture in a major surface of a disk-shaped glass substrate by lapping the major surface with a lapping member while supplying an abrasive material onto the major surface. In the step, the glass substrate is reciprocated in a radial direction while rotating the glass substrate around its center at a predetermine rotational speed. The rotational speed, the reciprocating speed, and the reciprocation stroke are so determined that the locus of every particle of the abrasive material crosses itself at least at three points.

### TECHNICAL FIELD

The present invention relates to a method for manufacturing a glass substrate having a main surface on which a texture is formed, and more specifically, to a method for manufacturing a glass substrate for an information recording medium, such as a magnetic disc, a magnetic optical disc, and an optical disc, arranged in an information recording device, such as a hard disc drive.

### BACKGROUND ART

Generally, a magnetic disc is manufactured by superimposing a magnetic film and a protective film on the main surface of a disc-shaped glass substrate. To record a large volume of data on the magnetic disc at high density, the main surface of the glass substrate is smoothly polished. However, a magnetic head for reading information from the magnetic disc and writing information to the magnetic disc tends to adhere to the magnetic disc when the main surface is smoothly polished. Accordingly, to reduce adherence of the magnetic head, Japanese Laid-Open Patent Publication No. 2001-101656 describes a mechanical texture formation process for forming a texture including a plurality of linear fine projections extending concentrically on the surface of the glass substrate. Japanese Laid-Open Patent Publication No. 2001-209927 describes a process for applying magnetic anisotropy in the circumferential direction of the magnetic disc by forming a texture so that linear fine projections intersect one another at an intersection angle in a range of 0.1 to 45°.

However, in a glass substrate having a texture formed through the conventional process, the smoothness of the surface is decreased even though a smoothening process is performed. Among the criteria indicating surface smoothness, microscopic undulation, which is measured with light in a wavelength of 0.2 to 1.4 mm using a three-dimensional surface structure analyzing microscope, tends to be high.

One of the causes of the above problem is that the processing condition for intersecting the linear fine projections at a predetermined angle is not fixed. That is, since various processing conditions exist for obtaining a predetermined intersection angle, the predetermined intersection angle and surface smoothness may be obtained under one processing condition, while the predetermined intersection angle may be obtained but the surface smoothness decreases under another processing condition. This is thought to be because even if the intersection angles are the same, a deep groove is formed at one portion of the texture, while a shallow groove is formed at another portion. This causes the texture to be uneven and decreases the smoothness of the glass substrate.

### DISCLOSURE OF THE INVENTION

The present invention aims to provide a glass substrate for an information recording medium having an even texture and high smoothness, and a method of manufacturing the same.

To achieve the above object, one aspect of the present invention is a method for manufacturing a glass substrate for an information recording medium including a step for forming a texture on a main surface of a disc-shaped glass plate by supplying an abrasive agent containing an abrasive grain to the main surface and slidably contacting the main surface with an abrasive member. The method includes oscillating either one of the abrasive member and the glass plate in a radial direction of the glass plate with respect to the other one of the abrasive member and the glass plate while rotating the glass plate so that the abrasive grain cyclically draws a one-stroke closed track that intersects in at least three locations on the main surface of the glass plate.

It is preferred that the frequency F (Hz) of the oscillation and rotation speed R (min⁻¹) of the glass plate are determined so that the rotation speed R is outside a range of (F×60)±5.

In one embodiment, the one-stroke closed track includes at least five intersections.

In one embodiment, the frequency of oscillation is greater than 0 Hz but 20 Hz or less.

In one embodiment, the rotation speed is 240 to 540min⁻¹.

In one embodiment, the stroke of the oscillation is 0.5 to 2 mm.

The abrasive member is a roller made of an elastic material having a duro hardness, as defined by ISO 7627-2, of 40 to 90.

In one embodiment, a step for scrubbing the main surface of the glass plate with a scrubbing material in which a 100% modulus, as defined by JIS K7113, is 2.9 to 39.2 MPa after the step of forming a texture.

The frequency of oscillation is greater than 0 Hz but 4 Hz or less when an outer diameter of the glass plate is 48 mm or less, and the frequency of oscillation is greater than 4 Hz but 20 Hz or less when the outer diameter is greater than 48 mm.

A further aspect of the present invention is a method for manufacturing a glass substrate for an information recording medium. The method includes preparing a disc-shaped glass plate having a main surface and a central circular hole, and forming on the main surface a texture including a plurality of grooves, each extending along a closed curve that intersects in at least three locations around the central circular hole.

In one embodiment, the step for forming a texture includes supplying an abrasive agent containing an abrasive grain to the main surface of the glass plate, pressing an abrasive member against the main surface of the glass plate, cyclically oscillating either one of the glass plate or the abrasive member in the radial direction of the glass plate, and rotating the glass plate at a constant speed.

It is preferred that the stroke of oscillation is 0.5 to 2 mm, and the frequency F (Hz) of oscillation and the rotation speed R (min⁻¹) of the glass plate are determined so that the rotation speed R is outside the range of (F×60)±5.

It is preferred that the frequency of oscillation is changed in accordance with an outer diameter dimension of the glass plate.

Another aspect of the present invention is a glass substrate for an information recording medium having a main surface on which a texture is formed. The main surface has an arithmetic mean roughness Ra, as measured by an atomic force microscope, of 0.5 nm or less, and the main surface has a microscopic undulation height NRa of 0.2 nm or less, as measured by a three-dimensional surface structure analyzing microscope using light having a measuring wavelength of 0.2 to 1.4 mm.

The texture of the glass substrate includes a plurality of projections. In a region having a predetermined reference area in the main surface, when setting a hypothetical reference plane traversing the plurality of projections so that the total value of the cross sectional area of the plurality of projections is 50% relative to the reference area, a first hypothetical plane parallel to the main surface and traversing the plurality of projections so that the total value of the cross sectional area of the plurality of projections is 0.4% relative to the reference area is separated from the hypothetical reference plane by a first distance. Further, a second hypothetical plane parallel to the main surface and traversing the plurality of projections so that the total value of the cross sectional area of the plurality of projections is 0.01% relative to the reference area is separated from the hypothetical reference plane by a second distance. The difference between the first distance and the second distance is 0.01 to 1.0 nm.

A further aspect of the present invention is a disc-shaped glass substrate for an information recording medium including a central circular hole and a main surface. A texture including a plurality of grooves, each extending along a closed curve that intersects in at least three locations around the central circular hole, is formed on the main surface.

### BRIEF DESCRIPTION OF THE DRAWINGS

FIG. 1 is a front view showing a glass substrate for an information recording medium according to the present invention.

FIG. 2A is a schematic side view showing a texture machine.

FIG. 2B is a schematic front view showing the texture machine.

FIG. 3A is a schematic enlarged view showing a texture.

FIG. 3B is a cross sectional view taken along line 3B-3B in FIG. 3A.

FIG. 3C is a cross sectional view taken along line 3C-3C in FIG. 3A.

FIGS. 4A and 4B are views showing tracks of an abrasive grain that forms grooves in the surface of a glass substrate when rotation and oscillation of the glass substrate are not synchronized.

FIGS. 5A, 5B, 6A, and 6B are views showing tracks of the abrasive grain on the surface of the glass plate when the rotation and the oscillation of the glass plate are synchronized.

FIGS. 7A and 7B are enlarged views of a roller of the texture machine pressed against the surface of the glass plate.

FIGS. 8 to 11 are graphs showing the relationship between a bearing ratio (BR) and a bearing height (BH) in the glass substrates of examples and comparative examples of the present invention.

### BEST MODE FOR CARRYING OUT THE INVENTION

A first embodiment of the present invention will now be described.

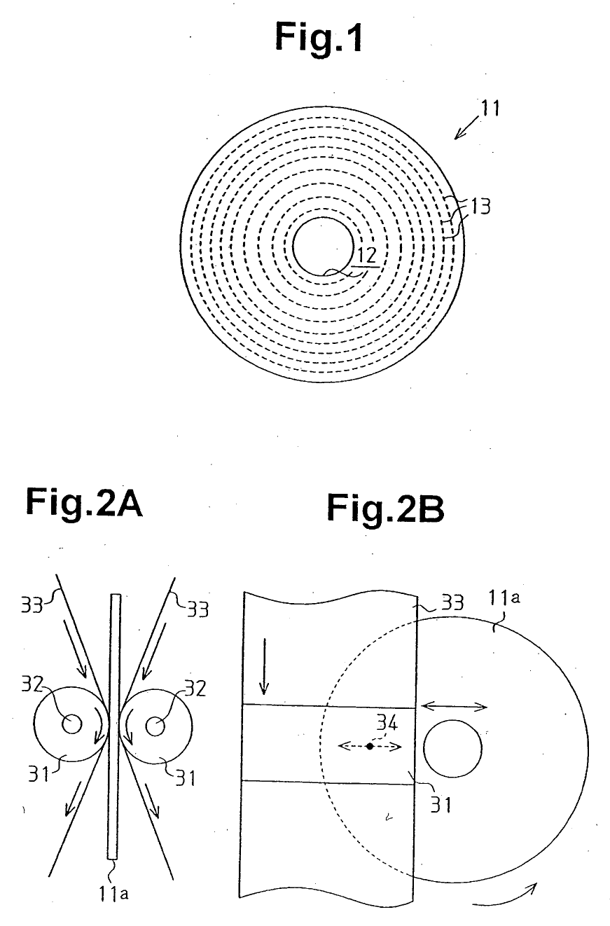

As shown in FIG. 1, an information recording medium glass substrate 11 is disc-shaped with a circular hole 12 extending through the center thereof. A texture 13 is formed on a main surface of the glass substrate 11. The glass substrate 11 is made of a multicomponent glass material such as soda lime glass, aluminosilicate glass, borosilicate glass, or crystallized glass manufactured through a float method, a downdraw method, a redraw method, or a press method. The glass substrate 11 is manufactured by cutting out a disc-shaped glass plate from a sheet of glass material, polishing the glass plate, and performing texture processing on the surface.

The texture 13 includes a plurality of ridges (projections) and a plurality of valleys. The ridges and valleys form a line intermittently extending towards the periphery of the glass substrate 11. A magnetic film, a protective film and the like made of a metal, such as cobalt (Co), chromium (Cr), and iron (Fe), or an alloy is formed on the main surface of the glass substrate 11, which has the texture 13, to obtain an information recording medium, such as a magnetic disc, a magnetic optical disc, and an optical disc. The formation of the texture 13 reduces the contact area between the recording surface of the information recording medium manufactured from the glass substrate 11 and a head.

A method for manufacturing the glass substrate 11 will now be explained.

The glass substrate 11 is manufactured through a disc machining step, an edge beveling step, a lapping step, a polishing step, a washing step, and a texture processing step.

In the disc machining step, a disc-shaped glass plate is cut out from a square glass material using a cutter made of a cemented carbide or diamond. In the edge beveling step, an outer circumferential edge and an inner circumferential edge of the glass plate are ground so that the outer diameter and inner diameter have predetermined dimensions and so that the corners of the outer circumferential edge and the inner circumferential edge are beveled. In the lapping step, a plurality of lapping processes are performed with a polishing apparatus to correct the warp of the glass plate. In the polishing step, a plurality of polishing process steps are performed with a polishing device to smoothen the main surface of the glass plate. In the washing step, subsequent to the polishing process, the glass plate is washed with a washing liquid to remove foreign materials, such as abrasive agent, abrasive grains, and dust, from the main surface of the glass substrate.

In the texture processing step, a texture machines is used to form a texture on the main surface of the glass plate through a mechanical texture formation process on the main surface of the glass plate that has been smoothened. The glass substrate 11 is manufactured in this manner.

The texture machine will now be explained.

As shown in FIG. 2A and FIG. 2B, in the texture machine, the glass plate 11a is rotatably supported by a spindle (not shown). The glass plate 11a is arranged between a pair of rollers 31 arranged so as to face each other. Each roller 31 is rotatably supported by a rotating shaft 32 extending in the radial direction of the glass plate 11a. Both rollers 31 are movable toward or away from the glass plate 11a.

A tape member 33 serving as an abrasive member is movably arranged between the main surface of the glass plate 11a and the corresponding roller 31. Between the main surface of the glass plate 11a and each roller 31, the tape member 33 moves from one side (upper side in FIG. 2A) to the other side (lower side in FIG. 2A). Abrasive agent is supplied from a supply section (not shown) to the space between the tape members 33 and the main surfaces of the glass plate 11a. Abrasive grains contained in the abrasive agent are adhered to the tape member 33. By moving the pair of rollers 31 toward the main surfaces of the glass plate 11a while rotating the glass plate 11a at a constant rotation speed, the tape member 33 slides along the main surface of the glass plate 11a. The sliding of the tape member 33 presses the abrasive grains against the main surface of the glass plate 11a and scrapes the main surface to form a plurality of linear fine grooves, that is, valleys in the texture. The ridges in the texture are defined between the valleys.

The abrasive grains contained in the abrasive agent have slightly different grain diameters. This produces differences in the depth and the width of the valleys formed by different abrasive grains, and the shapes of the ridges become uneven. For instance, at locations where valleys are deep and wide, the portion between valleys is greatly scraped. Thus, the ridges become low and narrow. Conversely, at locations where valleys are shallow and narrow, the portion between valleys is slightly scraped. Thus, the ridges become high and wide. The high and wide ridges connect with the low and thin ridges so as to distort a line (ridgeline) connecting the apexes of the ridges in an undulated manner. The distortion affects the microscopic undulation of the main surface.

In the conventional method for manufacturing a glass substrate, an abrasive member is only pressed against the rotating glass plate. The glass plate and the abrasive member are not oscillated. Therefore, the ridges and the valleys of the texture are formed concentrically. A track drawn on the main surface of the glass plate by an abrasive grain pressed against the glass plate is, as shown in FIG. 5A, a circle extending in the circumferential direction of the glass plate. In this case, a plurality of tracks do not intersect one another. That is, even if a relatively high ridge is formed at a certain location, the track of another abrasive grain does not traverse and scrape the ridge so as to correct the height of the ridge. Further, once a valley becomes deep and wide, abrasive grains easily enter the valley. Thus, a phenomenon occurs in which the same location of the main surface is scraped by the cyclic movement of the abrasive grains. Particularly, in case of a circular track, one abrasive grain is likely to follow the track of another abrasive grain. Thus, the above mentioned phenomenon is more likely to occur. As a result, when the entire main surface of the glass plate is viewed in a macroscopic manner, the shapes of the ridges, such as the heights and widths, are likely to differ between locations even in the same glass plate. Further, when an individual ridge is viewed in a microscopic manner, the shape of the ridgeline, especially, the heights of apexes tend to be uneven such that the ridgeline may be deformed greatly vertically and horizontally in one location and be flat at another location even in the same continuous ridge. Particularly, if the same location is deeply scraped in the main surface of the glass plate 11a, microscopically, a large non-scraped section will exist on the ridgeline of the ridge and an abnormal projection referred to as a burr is likely to form. If the shape of a ridgeline becomes uneven or the shapes of the ridges differ from each other when viewed macroscopically and microscopically, this would increase the elevation difference of the microscopic undulation and lower the surface quality of the glass substrate.

In the present specification, one cycle refers to the time required for an abrasive grain pressed against an arbitrary point (starting point) on the main surface of the glass plate to return to the same position (finishing point) as the starting point. In the present specification, cyclic movement refers to a movement for repeatedly drawing a track that is substantially the same at a time interval that is substantially the same.

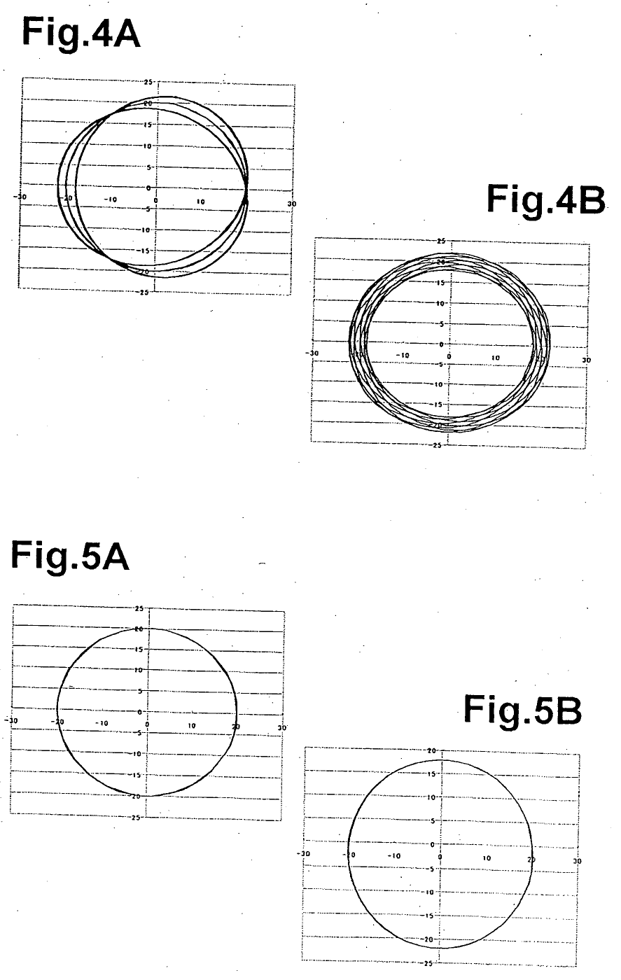

In the first embodiment, as shown in FIG. 2B, not only is the glass plate 11a rotated, but one of either the glass plate 11a or the roller 31 is oscillated at a predetermined frequency and stroke in the radial direction of the glass plate 11a. The tape member 33 slides along the main surface in this state. Focusing on one abrasive grain 34 on the tape member 33, as shown by dotted arrows in FIG. 2B, the abrasive grain 34 is cyclically oscillated in the radial direction of the glass plate on the main surface of the glass plate. Therefore, due to the contact with the abrasive grain 34, a cyclically undulated groove is formed in the main surface of the rotated glass plate 11a. Here, (refer to FIG. 4A), focusing on the glass plate 11a, the single abrasive grain 34 appears as if it is cyclically moving on the main surface of the glass plate 11a. In the example of FIG. 4A, the cyclically moving abrasive grain forms, in the main surface of the glass plate 11a, a groove is formed extending along a closed curve that intersects at three locations.

One cycle of the track shown in FIG. 5A corresponds to one rotation of the glass plate 11a. One cycle of the track of FIG. 4A corresponds to three rotations of the glass plate 11a. Therefore, compared to the length of the circular track of FIG. 5A, the length of one cycle of the track of FIG. 4A is longer. Macroscopically, valleys are formed on the entire main surface of the glass plate in a distributed manner. Thus, the phenomenon in which the same location of the main surface of the glass substrate is scraped by the cyclically moving abrasive grains seldom occurs. Further, since one track intersects in one cycle, if, for example, a high ridge is formed at one place, the abrasive grain aggressively scrapes the apex of such ridge and microscopically corrects the shape of the ridgeline. Especially, burrs are aggressively scraped off. Thus, in terms of removing burrs, the above shape in which there are intersections in the track of one cycle is effective.

Therefore, the ridges are formed so that, microscopically, in a state in which the shape of ridgelines or the heights of apexes are substantially the same, macroscopically, the ridges are substantially evenly distributed on the entire main surface of the glass plate. In this case, at the main surface of the glass plate, the elevation difference of the microscopic undulation becomes small. This prevents the surface quality of the glass substrate from being lowered. A method for intersecting the track of the cyclically moving abrasive grain within one cycle is hereinafter referred to as a “cross-hatch method” in the present specification.

In the cross-hatch method, to have the track drawn on the main surface of the glass plate in one cycle by the abrasive grain shaped as described above, the following processing conditions are preferable.

The oscillation frequency and the rotation speed (rotations per minute) of the glass plate 11a or the roller 31 are not synchronized and are preferably in a non-synchronized state. A state in which the oscillation frequency and the rotation speed are synchronized is a state in which the rotation speed R (min⁻¹) is within a range of (F×60)±5 when F(Hz) represents the oscillation frequency.

If, for example, the oscillation frequency F is 4 Hz and the rotation speed R is 4×60 or 240 min⁻¹ (240 rpm), the shape of the track for one cycle is an ellipse, as shown in FIG. 5B. This is thought to be because the starting point and the finishing point of oscillation of one abrasive grain 34 and the starting point and the finishing point of the track of one cycle coincide with each other by completely synchronizing the oscillation frequency F and the rotation speed R. That is, the above shape is formed by performing one oscillation within one cycle. In this case, in the same manner as the circular track, when seen macroscopically and microscopically, the shapes of the ridges differ from each other and thus the shape of the ridgeline tends to be uneven. This causes large differences in elevation of the microscopic undulation and lowers the surface quality of the glass substrate.

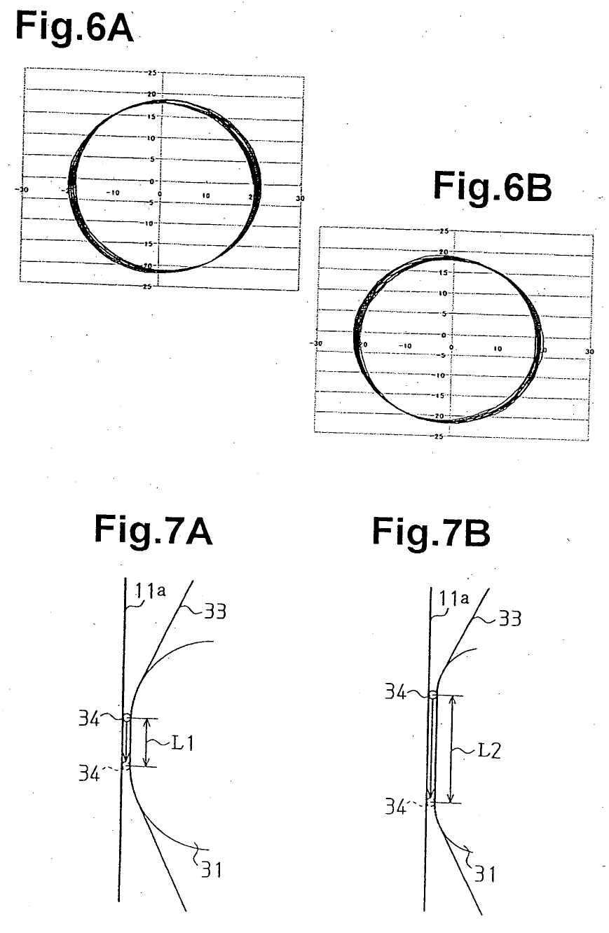

If the oscillation frequency F is 4 Hz and the rotation speed R is (4×60)+5, or 245 min ¹ (240 rpm), the track for one cycle forms, as shown in FIG. 6A, a shape that is closed in an intersecting manner from the starting point to the finishing point of one cycle. However, the track intersects only at two locations. At locations other than the two intersecting locations, the track is deviated substantially concentrically inwardly or outwardly. This is thought to be due to the fact that even if there is a slight deviation from a state in which the oscillation frequency F and the rotation speed R are completely synchronized, the oscillation frequency F and the rotation speed R are still in a substantially synchronized state. Thus, the influence thereof is caused only by the extremely slight deviation between the finishing point of oscillation and the finishing point of the track of one cycle. Further, the deviation of the track is thought to be caused by the displacement between the finishing point of oscillation and the finishing point of the track of one cycle.

If one track intersects at two locations in the track, at the two intersections and the vicinity thereof, the abrasive grain repeatedly passes through substantially the same location a number of times and thus the main surface of the glass plate is deeply scraped. In other locations, the main surface is shallowly scraped. Thus, macroscopically and microscopically, the shapes of the ridges differ from each other and causes the shape of the ridgeline to be uneven. This lowers the surface quality of the glass substrate. Further, if the rotation speed R is (4×60)−5 or 235 min¹ (235 rpm), the shape of the track of one cycle is as shown in FIG. 6B. This shape is substantially the same as that shown in FIG. 6A. Thus, the surface quality of the glass substrate is lowered for the same reason as mentioned above.

Although not shown in the drawings, from the state in which the oscillation frequency F and the rotation speed R are completely synchronized, if the rotation speed R, for example, is deviated within a range of −5 to 0, and 0 to +5, such as (F×60)+4 and (F×60)−3, the shapes of the tracks of one cycle become substantially the same as those shown in FIG. 6A and FIG. 6B. The shapes of the tracks differ in that the distance between the tracks are widened or narrowed at locations other than the two intersections. However, there are two intersections. Thus, the surface quality of the glass substrate is lowered.

If the oscillation frequency F and the rotation speed R are non-synchronized, for example, if the oscillation frequency F is 3 Hz and the rotation speed R is (3×60)+60 or 240 min⁻¹ (240 rpm), the shape of the track of one cycle is as shown in FIG. 4A. This is thought to be because the finishing point of oscillation of one abrasive grain 34 and the finishing point of the track of one cycle do not coincide since the oscillation frequency F and the rotation speed R are non-synchronized. That is, such shape is thought to be formed by performing oscillation a number of times within one cycle. In this case, macroscopically and microscopically, the shapes of the ridges are less likely to differ. Thus, the shape of the ridgeline is less likely to be uneven, the elevation difference of the microscopic undulation becomes small, and the surface quality of the glass substrate is maintained. Further, the shape also has an advantage in that burrs are less likely to be formed on the ridgeline of the ridges.

If, for example, the oscillation frequency F is 4.5 Hz and the rotation speed R is (4.5×60)−3 or 240 min⁻¹ (240 rpm), the shape of the track of one cycle is the shape shown in FIG. 4B. In this case, compared to the shape shown in FIG. 4A, the number of intersections of the track within one cycle is increased. When the number of intersections is increased, the shape of the ridgeline is further effectively corrected, microscopically, because, for example, the apexes of the ridges can be further aggressively scraped. In addition, the formation of burrs is suppressed.

In the present invention, as mentioned above, the number of intersections of the track within one cycle is important. This is because, with the increase in the number of intersections, the ridge of the texture is scraped in a wide range, thus reducing the non-scraped sections. Further, microscopically, the shape of the ridgeline is the same, and macroscopically, the entire main surface of the glass plate is scraped to a substantially even thickness. On the other hand, in the shapes shown in FIG. 6A and FIG. 6B, since the intersection angle of the track is between 4° and 9° and the intersection angle of the track shown in FIG. 4A is about 7°, the intersection angles are considered to be within substantially the same range. However, the shapes differ greatly between the tracks shown in FIG. 6A and FIG. 6B and the track shown in FIG. 4A. In the shapes shown in FIG. 6A and FIG. 6B, the surface quality is lowered. In the shape shown in FIG. 4A, the surface quality is maintained. Thus, defining the intersection angle between the tracks as in the conventional example is not an important factor in terms of maintaining the surface quality. Therefore, when maintaining the surface quality from the microscopic undulation point of view, the number of intersections of the track within one cycle is an important factor.

The number of intersections of the track within one cycle may be increased or decreased with the oscillation frequency F and the rotation speed R in the non-synchronized state and regulating the oscillation frequency F and the rotation speed R in more detail. To maintain the surface quality, the number of intersections of the track within one cycle is at least three. If there are less than three intersections like the shapes shown in FIG. 5A, FIG. 5B, and FIG. 6A, FIG. 6B, macroscopically and microscopically, the shapes of the ridges differ and the shape of the ridgeline becomes uneven. Further, to improve the surface quality, the number of intersections of the track within one cycle is preferably at least five. This is because with the increase in the number of intersections, the ridge section of the texture is scraped widely. Thus, microscopically, the shapes of the ridgelines are the same, and macroscopically, the entire main surface of the glass plate is scraped to a substantially even thickness.

As the movement distance of the abrasive grain on the main surface of the glass plate becomes longer or as the movement speed with respect to the glass plate becomes faster, the track drawn by the abrasive grain becomes longer and intersecting of the tracks is further ensured. However, when viewed from above, the glass plate has a circular shape. The movement distance of abrasive grains is longer for abrasive grains located closer to the outer diameter of the glass plate and shorter for abrasive grains located closer to the inner diameter. Further, the movement speed of the abrasive grain is faster for the abrasive grains located closer to the outer diameter of the glass plate and slower for the abrasive grains located closer to the inner diameter.

Therefore, when performing the cross-hatch method, unless the portion of the inner diameter side of the glass plate is contacted by the abrasive grain for a sufficient time, the tracks of the abrasive grain do not sufficiently intersect at the portion of the inner diameter side. This may lower the surface quality. Particularly, in the texture machine shown in FIG. 2B, the portion of the outer diameter side of the glass plate 11a is constantly slidably contacted by the tape member 33 during oscillation, but at the portion of the inner diameter side, a time in which the tape member 33 temporarily does not slidably contact the glass plate exists. To shorten or eliminate the time in which such portion of the inner diameter side is temporarily not slidably contacted by the tape member 33, the oscillation frequency and the oscillation stroke are preferably regulated in more detail.

More specifically, the oscillation frequency is preferably greater than 4 Hz but 20 Hz or lower. If the oscillation frequency is 4 Hz or lower, the time required for the glass plate to return from the starting point to the finishing point of oscillation becomes longer. Thus, the time in which the tape member 33 temporarily does not slidably contact the portion of the inner diameter side becomes longer and, macroscopically, may cause a difference in the shapes of the ridges and lower the surface quality. Further, if the oscillation frequency exceeds 20 Hz, the time in which the tape member 33 slidably contacts the portion of the outer diameter side of the glass plate becomes unnecessarily long. Such portion of the outer diameter side may be over-scraped by the abrasive grain, and macroscopically, may adversely cause a difference in the shapes of the ridges and lower the surface quality.

The oscillation stroke is preferably between 0.5 and 2 mm. If the oscillation stroke is less than 0.5 mm, the distance between tracks of the abrasive grains becomes unnecessarily close, and a single wide groove is formed when a plurality of grooves are concentrated. If a plurality of grooves are concentrated, even if the glass plate is oscillated, it may appear as if the conventional concentric texture is formed. If the oscillation stroke exceeds 2 mm, the time required for the glass plate to return from the starting point to the finishing point of oscillation becomes longer. Thus, the time in which the tape member 33 temporarily does not slidably contact the part of the inner diameter side also becomes longer. In this case, macroscopically, differences occur in the shapes of the ridges and the surface quality is lowered.

The rotation speed is preferably between 240 and 540 min⁻¹ (240 to 540 rpm). If the rotation speed is less than 240 min⁻¹, the movement distance of the abrasive grain in one oscillation becomes short. Thus, the intersections of the tracks may not be three or greater. Further, if the rotation speed exceeds 540 min⁻¹, the width or the length of the formed ridge becomes extremely short and the texture function cannot be achieved.

The tape member 33 is for example, a cloth, a nonwoven cloth, a flocked sheet, or a suede sheet. Such a tape member 33 is preferable since the surface thereof includes microscopic bumps and can thus hold the abrasive grains of the abrasive agent with the microscopic bumps. Further, synthetic resin such as polyurethane, polyethylene, and polypropylene, and natural fibers, such as cotton, may be used as the material for the tape member 33. A suede sheet formed from foam made of synthetic resin may also be used.

Diamond slurry obtained by dispersing diamond abrasive grains in a dispersion medium, such as water, is mainly used as the abrasive agent. The mean grain diameter (D₅₀) of the abrasive grain is preferably between 0.05 and 0.3 μm, and more preferably between 0.08 and 0.25 μm. If D₅₀ is less than 0.05 μm, the polishing capability of the glass plate decreases, and the formation speed of the texture decreases. Thus, the yield decreases, and the processing cost increases. If D₅₀ exceeds 0.3 μm, the difference between the grain diameters of the abrasive grains becomes significant and formation of an even texture becomes difficult.

The roller is made of an elastic material, such as synthetic rubber, natural rubber, and elastomer, having a duro hardness, as defined by ISO 7627-2, of preferably 40 to 90. The relationship between the hardness of the roller 31 and the track of the abrasive grain will now be explained.

As shown in FIG. 7A and FIG. 7B, the roller 31 elastically deforms when pressed against the glass plate 11a. In the case of FIG. 7A, a single abrasive grain 34 contacts the glass plate 11a during a period in which the abrasive grain 34 moves the same distance as the contact width L1 when the tape member 33 moves and then moves away from the main surface of the glass plate 11a. That is, the single abrasive grain 34 may not necessarily finish drawing the track of one cycle as mentioned above while contacting the glass plate 11a and may draw a track of half of a cycle or a quarter of a cycle depending on the length of the contact width L1.

To maintain the surface quality, it is preferable to have one abrasive grain 34 contact the main surface of the glass plate 11a as long as possible and to have tracks intersect in as many locations within one cycle. This is because as the contacting time of the abrasive grain 34 shortens, due to the slight deviation in the contacting position between abrasive grains with respect to the main surface of the glass plate 11a, the valleys formed are slightly deviated from each another, and thus the track is less likely to intersect. Therefore, to have one abrasive grain 34 contact the main surface of the glass plate 11a as long as possible, the contact width of the roller 31 with respect to the glass plate 11a must be large. The degree of elastic deformation differs depending on the duro hardness of the roller 31. Thus, the duro hardness of the roller 31 is regulated to obtain a relatively large contact width L2, as shown in FIG. 7B.

If the duro hardness of the roller 31 is less than 40, the roller 31 becomes too soft. Thus, the force for pressing the abrasive grain 34 against the glass plate 11a becomes insufficient and the texture is not formed with sufficient height. Further, if the roller 31 having duro hardness of over 90 is used, the contact width cannot be widened sufficiently.

The force of a pair of rollers 31 pressing the abrasive grain 34 against the main surface of the glass plate 11a is preferably between 13.4 to 44.5N (3.01 to 10.0 lbs). If the pressing force is less than 13.4N (3.0 lbs), the contact width of the roller 31 may not be widened or the abrasive grain 34 may not be sufficiently pressed against the glass plate 11a and thus the texture may not be formed with sufficient height. If the pressing force exceeds 44.5N (10.0 lbs), the glass plate 11a held between the pair of rollers 31 may break or a resistance may be produced when the glass plate 11a is rotated.

After the texture processing step by the above mentioned cross-hatch method, a scrubbing step is preferably performed. When the texture is formed with the cross-hatch method, most of the ridges microscopically have the same ridgeline. However, burrs may sometimes be formed.

A method of forming the texture includes, besides the above mentioned mechanical texture forming method, a chemical texture forming method. The chemical texture forming method is a method for etching the main surface of the glass plate and forming the texture using an aqueous acid such as hydrofluoric acid and an etchant such as an alkaline aqueous solution. The chemical texture forming method is advantageous in that burrs are less likely to form because the entire main surface of the glass plate is etched. However, in the chemical texture forming method, once a burr is formed, layers having different chemical properties are formed on the surface of the burr. Such layer coats the surface of the burr and protects the burr. Therefore, the chemical texture forming method has a disadvantage that burrs cannot be easily removed.

Conversely, in the mechanical texture forming method, non-scraped sections tend to exist when scraping the main surface of the glass plate with the abrasive grain. Thus, the mechanical texture forming method is generally considered as a method in which burrs are formed more easily than the chemical texture forming method. However, the burrs are formed when the surrounding of the burrs are scraped with the abrasive grain and are thus non-scraped sections. Cracks are thereby found in the surface of burrs formed in the mechanical texture forming method. Therefore, the burrs formed by the mechanical texture forming method can be sufficiently bent and removed from their basal portions by a physical means and can be more easily removed compared to burrs formed by the chemical texture forming method.

In the present embodiment, during the scrubbing step, a washing liquid is showered on the main surface of the glass plate and the main surface is scrubbed with a scrubbing material. This eliminates foreign materials, such as abrasive grains and glass powder that are left on the main surface of the glass plate. Further, abnormal projections referred to as burrs are removed.

Sponges including foam made of synthetic resin and suede materials are used for the scrubbing material. A scrubbing material having a 100% modulus as defined by JIS K7113 of preferably 2.9 to 39.2 MPa (30 to 400 kgf/cm²) is used. Further, a scrubbing material having an Asker C hardness as defined in SRISO101 of preferably 40 or greater is used. When the scrubbing material having 100% modulus of less than 2.9 MPa (30 kgf/cm²), or Asker C hardness of less than 40 is used, the strength of burrs is stronger than the scrubbing material and thus burrs are not sufficiently removed. In case of an extremely hard scrubbing material having 100% modulus of more than 39.2 MPa (400 kgf/cm²), the formed texture also becomes scrubbed off.

The washing liquid may be a neutral aqueous solution, such as water, purified water, or alcohol, such as isopropyl alcohol. Other neutral aqueous solutions may be electrolytic water obtained by electrolyzing an aqueous solution of inorganic salt like alkali metal salt such as sodium chloride or function water such as gas dissolved water in which the gas is dissolved. Further, an alkaline aqueous solution or aqueous acid having the capability for etching a glass material may also be used as the washing liquid. In this case, an alkali aqueous solution such as a calcium hydroxide aqueous solution having a low capability for etching a glass material is preferably used.

The fact that burrs formed by the mechanical texture forming method is removable by a physical means in the scrubbing step has been discovered for the first time through many experiments and analysis of the results thereof performed by, for example, the inventors of the present invention. That is, since burrs are microscopic and are recognizable only through the use of a measuring apparatus such as an AFM, and the surface thereof cannot be finely scanned, cracks formed thereon are extremely microscopic that cannot be recognized even when using the measuring apparatus. Thus, in terms of merely cleaning the main surface of the glass plate in the conventional scrubbing step, the process of using the cracks in burrs to bend and remove the burrs can not be easily analogized.

Further, although departing from the purpose of the present invention, the above mentioned scrubbing step has a sufficient effect even when removing burrs from the conventional texture, having concentric circles, formed by the mechanical texture forming method. That is, by using the scrubbing material in which 100% modulus is between 2.9 and 39.2 MPa or the scrubbing material in which the Asker C hardness is 40 or greater, the formed burr can be sufficiently removed in all the mechanical texture forming methods including the cross-hatch method.

In the glass substrate having the texture manufactured as above, the height (NRa) of the microscopic undulation of the main surface is 0.2 nm or less, and the surface roughness (Ra) is 0.5 nm or less. Further, the height (Wa) of the undulation of the main surface in this case is preferably 0.5 nm or less. Here, NRa indicates a value measured by scanning a predetermined region of the main surface with a white light in a measuring wavelength (λ) of 0.2 to 1.4 mm using a three-dimensional surface structure analyzing microscope (New View 200) made by Zygo Corporation. Ra indicates a value measured with an atomic force microscope (AFM). Wa indicates a value measured by scanning a predetermined region of the main surface with a white light with a measuring wavelength (λ) of 0.4 to 5.0 mm using a multifunctional disc interferometer (Optiflat) made by Phase Metrix Corporation.

If NRa exceeds 0.2 nm, and Ra exceeds 0.5 nm, the main surface of the glass substrate is rough and has a low smoothness. This is based on the background that recent information recording media tend to have the distance between the main surface of the information recording medium and the head closer to further achieve high density recording. When the head moves on the information recording medium, the head follows the undulation even if the height Wa of undulation is slightly large. However, if NRa and Ra are large, the head does not follow the microscopic undulation and cannot jump over an abnormal projection. Thus, the head may be caught by an abnormal projection or hit an abnormal projection.

If the smoothness of the main surface is excessively high, the head becomes adhered to the main surface of the information recording medium and disables movement of the head. Thus, the texture is formed to reduce the contact area with the head while smoothing the main surface of the glass substrate. The texture functions to suppress the adhesion of the head to the main surface of the information recording medium by reducing the contact area with the head. Further, the texture applies high magnetic anisotropy and coercive force to the information recording medium manufactured from the glass substrate. This is thought to be because the atoms of the metal forming the magnetic film are arranged in a satisfactory orientation at the side surface of the texture.

A method for measuring the surface quality of the glass substrate includes using a bearing ratio (BR) and a bearing height (BH). According to the method using the BR and the BH, besides the shape of the texture, the presence of burrs can also be measured. BR will now be described.

To obtain BR, first the surface condition is measured at a predetermined region of the main surface of the glass substrate using the AFM. In compliance with JIS B0601, the AFM is capable of obtaining the roughness curve for every scanning line, and the bumps of the main surface of the glass substrate can be shown as a bird's eye view based on the roughness curve. The area of the measured predetermined region is set as a reference area. For instance, if the measured predetermined region is 5 μm square, the reference area is 25 μm².

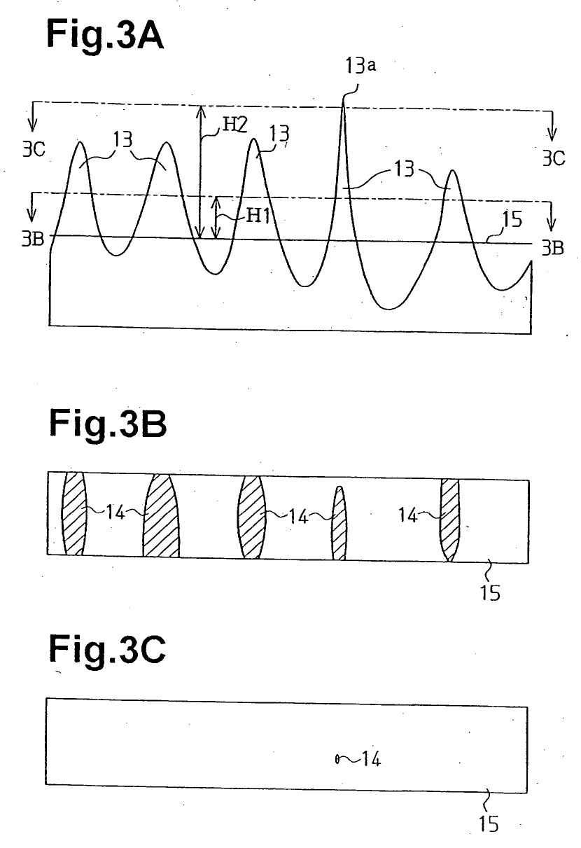

Secondly, as shown in FIGS. 3A to 3C, the texture 13 is cut at a plane parallel to the main surface of the glass substrate 11. Here, each cutting plane 14 of when the texture 13 is cut along a plane lying along the 3B line in FIG. 3A is shown in FIG. 3B, and the cutting plane 14 of when the texture 13 is cut along a plane lying along 3C line is shown in FIG. 3C. Subsequently, the area of the cutting plane 14 of the texture 13 is calculated. The area of the cutting planes 14 is the measured area.

The ratio of the measured area with respect to the above mentioned reference area is indicated as BR. If, for instance, the ratio of the measured area with respect to the reference area is 50%, BR is 50%, and if the ratio is 0.01%, BR is 0.01%.

BH will now be explained.

To obtain BH, first the position at where BR is 50% is obtained. The position at where BR is 50% is the reference plane 15 shown in FIG. 3A. Secondly, a plane at where the texture is cut when the BR is a predetermined value is obtained. The plane at where the texture is cut is the measurement plane. In FIG. 3A, the plane including the 3B line or the plane including the 3C line is the measurement plane. The height from the reference plane 15 to the measurement plane is shown as BH. For instance, when the plane including the 3B line is the measurement plane, and if BR is 10%, this is indicated as BH(10), and if the height H1 from the reference plane 15 to the measurement plane including the 3B line is 0.5 nm, BH(10) is 0.5 nm. Further, when the plane including the 3C line is the measurement plane, and if BR is 0.1%, this is indicated as BH(01) and if the height H2 from the reference plane 15 to the measurement plane including the 3C line is 1.5 nm, BH(01) is 1.5 nm.

When measuring the surface quality of the glass substrate using the above mentioned BR and BH, the BH for every predetermined BR is measured, the difference for every measured BH is obtained, and the difference is evaluated to measure the shape of the texture and the presence of a burr. That is, regarding the texture, the area for the cutting plane becomes smaller towards the upper end of each ridge as shown in FIG. 3A. If the ridge has a ridge shape of constant gradient, the BR becomes smaller at a constant ratio. In proportion to the BR, the BH becomes higher and the difference for every BH also becomes substantially constant. However, if a ridge thins suddenly and becomes high mid-way, or as shown in FIG. 3A, has a thinly projecting burr at the upper end thereof, the difference for every BH changes. Therefore, in the manufactured glass substrate, the texture can be formed into an even shape and burrs may be prevented by setting the difference for every BH to a predetermined value.

In the glass substrate, the difference (BH(001)−BH(04)) between BH(001) when BR is 0.01% and BH(04) when BR is 0.4% is preferably between 0.01 and 1.0 nm and more preferably between 0.2 and 0.7 nm. If BH(001)−BH(04) is less than 0.01 nm, a dent is formed on the ridgeline of the ridges. If BH(001)−BH(04) exceeds 1.0 nm, a thinly projecting burr 13a is formed on the ridgeline, as shown in FIG. 3A.

The above range is a range obtained as a result of noticing, for the first time, that burrs are produced within a range of BH(001) and BH(04) by the present inventors from the bird's eye view with the AFM. That is, from the bird's eye view with the AFM, the thinly projecting portions are observed in many places on the ridgeline, and thus by defining such thinly projecting portions as burrs, the burrs existed within a range of BH(001) to BH(04). Therefore, by setting the BH(001)−BH(04) to between 0.01 and 1.0 nm, the formation of burrs is prevented.

As a result of evaluating the shape of individual ridges from a microscopic point of view, the difference (BH(04)−BH(1)) between BH(04) when BR is 0.04% and BH(1) when BR is 1.0% is preferably between 0.15 and 0.2 nm, and more preferably between 0.17 and 0.20 nm. If BH(04)−BH(1) is less than 0.15 nm, the apex of a ridge is high and is formed in a projecting manner. If BH(04)−BH(1) exceeds 0.2 nm, the apex of a ridge is low and is formed in a dented manner.

The difference (BH(1)−BH(15)) between BH(1) and BH(15) when BR is 15.0% is preferably BH(04)−BH(1) or less. This is because the shape in which the height increases at a substantially constant gradient in the range of BH(15) to BH(04) is preferable for the texture. If the gradient suddenly increases at such portion, the texture in which the height of the ridges is low is formed and if the gradient suddenly decreases, the peak of the gradient becomes higher than the above range and the presence of burrs or the presence of ridges having a high projecting apex is suggested.

The first preferred embodiment has the following advantages.

When forming the texture on the glass plate using the mechanical texture forming method, the glass substrate 11 uses the cross-hatch method. With the cross-hatch method, the abrasive grain draws, on the main surface of the glass plate, a closed track that intersects in at least three locations from the starting point to the finishing point of one cycle. Thus, adverse effects such as the same location of the glass plate being scraped, or large non-scraped sections being formed are prevented, and the glass substrate in which the NRa of the main surface is 0.2 nm or less and the RA of the main surface is 0.5 nm or less is manufactured. Therefore, a bumpy texture is formed without lowering the smoothness of the main surface.

In the cross-hatch method, the rotation speed R of the glass plate and the oscillation frequency of the roller are non-synchronized. This allows the abrasive grains to reliably draw, on the main surface of the glass plate, a closed track extending from the starting point to the finishing point of one cycle that intersects in at least three locations. Therefore, lowering of smoothness of the main surface is effectively suppressed.

It is preferred that there are five or more intersections in the track of an abrasive grain. By having five or more intersections, the apex of the ridges forming the texture is aggressively scraped and the shape of the ridgeline is corrected in a more satisfactory manner.

The range of the oscillation frequency is set to be greater than 4 Hz but 20 Hz or lower, the range of the rotation speed is set between 240 and 540 min⁻¹, and the range of the oscillation stroke is set between 0.5 and 2 mm. Thus, the track of an abrasive grain intersects in at least three locations, and the texture is shaped evenly.

In the manufactured glass substrate, BH(001)−BH(04) is between 0.01 and 1.0 nm. Thus, burrs are prevented from forming on the ridgeline of the ridges.

A second embodiment of the present invention will now be described. The following description focuses mainly on the differences with the first embodiment.

As shown in FIG. 1, the configuration, such as the shape, of the glass substrate 11 of the second embodiment is the same as the glass substrate 11 of the first embodiment except for dimensions, such as, the outer diameter, and is formed into a disc-shape with a circular hole 12 extending through the center and a texture 13 formed on the main surface. The glass substrate 11 of the second embodiment has a smaller outer diameter compared to the glass substrate 11 of the first embodiment. More specifically, a substrate having an outer diameter greater than 48 mm, such as 65 mm (2.5 inches) and 95 mm (3.5 inches), is referred to as a large diameter substrate. The glass substrate 11 of the first embodiment is a large diameter substrate. A substrate having an outer diameter of 48 mm (1.8 inches) or less is referred to as a small diameter substrate. The glass substrate 11 of the second embodiment is a small diameter substrate.

A method for manufacturing the glass substrate 11 of the second embodiment will now be explained.

The glass substrate is manufactured through a disc machining step, an edge beveling step, a lapping step, a polishing step, a washing step, and a texture processing step. Each of the steps from the disc machining step to the washing step is the same as the previously mentioned steps.

In the texture processing step, the cross-hatch method is performed using the above mentioned texture machine.

That is, as shown in FIG. 2A and FIG. 2B, the texture is formed by oscillating the glass plate 11a in the radial direction at a predetermined oscillation frequency and oscillation stroke with respect to the roller 31 while rotating the glass plate 11a and sliding the tape member 33 along the main surface. The track drawn by a cyclically moving abrasive grain on the main surface of the glass plate 11a in one cycle has a closed shape that intersects in at least three locations from the starting point to the finishing point of one cycle. Further, in the small diameter substrate, the track preferably intersects in at least sixteen locations from the starting point to the finishing point of one cycle. This is because if the track intersects in at least sixteen locations, the quality of the main surface of the small diameter substrate is maintained while ensuring the texture with the cross-hatch method.

When performing the cross-hatch method, the movement distance of the abrasive grain on the main surface of the glass plate, which has a circular shape when viewed from above, tends to be longer for those located at the outer diameter side and shorter for those located at the inner diameter side, as mentioned above. Further, the movement speed of the abrasive grain tends to be faster for those located at the outer diameter side of the glass substrate and slower for those located at the inner diameter side. These tendencies are more significant in a small diameter substrate than in a large diameter substrate. One abrasive grain may not necessarily finish drawing the track of one cycle on the main surface of the glass plate.

In the small diameter substrate, the movement distance of the abrasive grain is short and the movement speed is slow especially at the inner diameter side of the main surface. Thus, the length of the track drawn by the abrasive grain becomes significantly short, and most of the abrasive grains leaves the main surface of the glass plate before the tracks sufficiently intersects. If the track of an abrasive grains does not sufficiently intersect, the shapes of the ridges are likely to become different. Thus, when performing the cross-hatch method for the small diameter substrate, the track of an abrasive grain must intersect at the shortest possible length.

Accordingly, in the cross-hatch method for a small diameter substrate, the intersection angle between tracks is preferably made as small as possible. This is because as the intersection angle becomes small, the length of the track necessary for intersection becomes short. More specifically, the intersection angle between tracks is preferably greater than 0° and 13° or smaller, and more preferably greater than 0° and 9° or smaller. If the intersection angle is 0°, the track of an abrasive grain does not intersect or a groove is formed at the same location. If the intersection angle exceeds 13°, the length of the track necessary for intersection becomes difficult to obtain in the small diameter substrate. Further, most of the abrasive grains leave the main surface of the glass plate before the tracks intersect. In a large diameter substrate, the tracks drawn before most of the abrasive grains leave the main surface of the glass plate have a length sufficient for enabling intersection. Thus, the intersection angle between the tracks is not a problem and the number of intersections of the tracks is considered to be an important factor. Conversely, in a small diameter substrate, the tracks may not even intersect and thus not only the number of intersections of the tracks but also the intersection angle is an important factor.

When performing the cross-hatch method using the texture machine, a portion where the tape member 33 does not contact the main surface of the glass substrate exists near the inner rim on the main surface of the glass substrate. This prevents the roller 31 from contacting the spindle during oscillation. The proportion of the portion occupying the entire main surface of the glass plate 11a is extremely small in a large diameter substrate but is large in a small diameter substrate. Thus, the area of the portion where the tape member 33 does not contact the main surface must be reduced as much as possible. Further, to reduce the intersection angle and reduce the area of the non-contact portion, processing conditions such as the oscillation frequency, the oscillation stroke, and the rotation speed, are set in the cross-hatch method for the small diameter substrate.

The processing conditions when performing the cross-hatch method for the small diameter substrate will now be explained.

In the cross-hatch method for the small diameter substrate, the oscillation frequency and the rotation speed of the glass plate 11a with respect to the roller 31 are also preferably non-synchronized. When the oscillation frequency F and the rotation speed R are synchronized, the track drawn by the abrasive grain 34 on the main surface of the glass plate 11a becomes a circle or an ellipse, as mentioned above. In this case, macroscopically and microscopically, a difference in the shapes of the texture is caused and the difference in elevation of the microscopic undulation becomes large and the surface quality may be lowered.

In the cross-hatch method for a small diameter substrate, to lengthen the time required for the glass plate to return from the starting point to the finishing point of oscillation, the oscillation frequency is preferably reduced compared to the cross-hatch method for the large diameter substrate. In a large diameter substrate, this is not a problem since the tracks of the abrasive grain 34 are long and are likely to intersect. Rather, due to its large area, formation of the texture on the entire main surface is a problem in a large diameter substrate. Thus, the oscillation frequency is increased to shorten the time required for the glass plate to return from the starting point to the finishing point of oscillation. The small diameter substrate has a small area and thus the texture can be easily formed evenly on the entire main surface. However, the length of the tracks of the abrasive grain 34 is short and thus is difficult for the tracks to intersect. By lowering the oscillation frequency and lengthening the time required for the glass plate to return from the starting point to the finishing point of oscillation, the time the tape member 33 slidably contacts the same location on the main surface of the glass plate is extended and the length of the track drawn by one abrasive grain becomes longer. When the oscillation frequency is extremely low, the tracks do not intersect and the shapes of the ridges may differ from each other or the shape of the ridgeline may be uneven. This causes the microscopic undulation to be large and lowers the surface quality.

More specifically, the oscillation frequency is preferably greater than 0 Hz but 4 Hz or less, and more preferably, 0.5 to 2 Hz. If the oscillation frequency F exceeds 4 Hz, the time during which the tape member 33 contacts the main surface of the glass plate, especially, the portion at inner diameter side, becomes insufficient. In this case, the tracks of the abrasive grain does not have sufficient length for intersection. Thus, the texture is formed unevenly, the microscopic undulation increases, and the surface quality may be lowered. If the oscillation frequency is 0 Hz, the glass plate 11a does not oscillate with respect to the roller 31 and the tracks of the abrasive grains do not intersect.

The oscillation stroke is preferably small compared to the large diameter substrate. This is because the outer diameter of the small diameter substrate is smaller than the outer diameter of the large diameter substrate. The oscillation stroke is preferably 0.5 to 1 mm. If the oscillation stroke is less than 0.5 mm, the distance between the tracks of the abrasive grains becomes unnecessarily close. This concentrates a plurality of grooves and forms one wide groove so that it appears as if the conventional concentric texture is formed. If the oscillation stroke exceeds 1 mm, the time required for the glass plate to return from the starting point to the finishing point of oscillation becomes long. Thus, the time in which the tape member 33 temporarily does not contact the portion of the inner diameter side becomes longer. This may lower the surface quality.

It is preferred that the rotation speed of the small diameter substrate be faster than that of the large diameter substrate. This is to lengthen the track drawn per unit time by the abrasive grain. The rotation speed is preferably 300 to 540 min⁻¹ (300 to 540 rpm). If the rotation speed is less than 300 min⁻¹, the movement distance of the abrasive grain in one oscillation becomes short. Thus, the track becomes short and may not intersect. Further, if the rotation speed exceeds 540 min⁻¹, the width or the length of a formed ridge may be extremely short, and the texture function may not be achieved.

Diamond slurry obtained by dispersing abrasive grains made of diamond in a solvent, such as water, is mainly used for the abrasive agent. The grain diameter of the abrasive grain is preferably smaller than that of the large diameter substrate. By decreasing the grain diameter of the abrasive grain, the force of the pair of rollers 31 pressing the abrasive grain against the main surface of the glass plate is increased to clearly and reliably form the groove. The grain diameter of the abrasive grain is such that the mean grain diameter (D₅₀) is preferably 0.085 to 0.155 μm. If D₅₀ is less than 0.085 μm, the width of the formed ridges is extremely wide and the texture function may not be achieved. If D₅₀ exceeds 0.155 μm, the abrasive grain is not sufficiently pressed against the main surface of the glass plate and a texture having a satisfactory shape is not formed.

The duro hardness, which is defined by ISO 7627-2 is preferably 40 to 90. If the duro hardness is less than 40, the force of pressing the abrasive grain against the main surface of the glass plate becoming insufficient, and displacement of the abrasive grain with respect to the glass plate occurs. Thus, a texture having satisfactory shape may not be formed. If the duro hardness exceeds 90, the contact width of the roller 31 with respect to the glass plate becomes short and the track drawn by the abrasive grain becomes shorter. Thus, the track may not intersect. Further, the force of the roller 31 may act locally, causing the glass plate to break.

The force of the pair of rollers 31 pressing the abrasive grain against the main surface of the glass plate is preferably weaker than that for the large diameter substrate. This is to suppress breakage of the glass plate by the pressing force. If the pressing force is excessively weakened, the valleys may not be clearly and reliably formed in the main surface of the glass plate. Thus, the force of the pair of rollers pressing the abrasive grain against the main surface of the glass plate is preferably 13.3 to 26.7 N (3.01 to 6.0 lbs). If the pressing force is less than 13.3 N (3.0 lbs), the contact width of the roller 31 may not be widened or the abrasive grain 34 may not be sufficiently pressed against the glass plate. Thus, the ridges may not be formed with a sufficient height. If the pressing force exceeds 26.7 N (6.0 lbs), the glass plate held between the pair of rollers 31 may break, and if the glass plate is rotated, the glass plate may adversely become a resistance.

After the texture processing step of the cross-hatch method, the above mentioned scrubbing step is preferably performed. This is to remove burrs from the texture formed by the cross-hatch method. In the glass substrate, which is a small diameter substrate, that has undergone the texture processing, the height (NRa) of the microscopic undulation of the main surface is 0.2 nm or less than, and the surface roughness (Ra) is 0.5 nm or less. Further, the height (Wa) of the undulation of the main surface in such case is preferably 0.5 nm or less.

In the texture of the relevant glass substrate, BH(001)−BH(04) is preferably 0.01 to 1.0 nm, and more preferably, 0.2 to 0.7 nm. BH(04)−BH(1) is preferably 0.15 to 0.2 nm, and more preferably, 0.17 to 0.20 nm. BH(1)—BH(15) is preferably BH(04)−BH(1) or less.

The second embodiment has the following advantages.

According to the glass substrate of the second embodiment, by forming the texture on the glass plate with the cross-hatch method, the tracks of the abrasive grains drawn on the main surface of the glass plate intersect. Thus, adverse effects such as scraping the same location of the glass plate or leaving large non-scraped sections are prevented. Further, the glass substrate in which NRa of the main surface is 0.2 nm or less and Ra is 0.5 nm or less is manufactured. Therefore, a bumpy texture is formed without lowering the smoothness of the main surface.

Further, the glass substrate of the second embodiment is a small diameter substrate having an outer diameter of 48 mm or less. In the small diameter substrate, the length of the tracks of the abrasive grain is shorter than the large diameter substrate. Further, a track does not easily intersect. Thus, in the small diameter substrate, the number of intersections of the track is preferably 16 or greater. That is, by increasing the intersections compared to the large diameter substrate, the small diameter substrate is configured to ensure that the track intersects.

Further, in the small diameter substrate, the intersection angle between tracks is greater than 0° and 13° or smaller. By narrowing the intersection angle, tracks become closer to each other so that the tracks intersect even if the tracks are short. This ensures that the tracks intersect and forms an even texture without lowering the smoothness of the main surface.

In the cross-hatch method, in correspondence with a small diameter substrate having an outer diameter smaller than that of a large diameter substrate, the range of the oscillation frequency is set low, the range of the oscillation stroke is set short, and the range of the rotation speed is set high. Thus, even in the cross-hatch method for the small diameter substrate, the tracks intersect, and a bumpy texture is formed without lowering the smoothness of the main surface.

Examples of the present invention will now be explained.

### EXAMPLE 1 AND COMPARATIVE EXAMPLE 1

A texture was formed in accordance with the mechanical texture forming method using the texture machine shown in FIG. 2 on the main surface of the glass plate, which was made of aluminosilicate glass produced through the float method. The composition of the glass plate was 63 mol % of SiO₂, 16 mol % of Al₂O₃, 11 mol % of Na₂, 4 mol % of Li₂O, 2 mol % of MgO, and 4 mol % of CaO. Further, the dimensions of the glass plate were such that the thickness was 0.65 mm, the outer diameter was 65 mm, and the inner diameter was 20 mm.

In the mechanical texture forming method, an abrasive agent including diamond abrasive grain having a mean grain diameter of 0.2 μm was used. The glass substrates of example 1 and comparative example 1 were obtained under the processing conditions shown in table 1. In example 1, the tracks of an abrasive grain were shaped as shown in FIG. 4B, and the number of intersections between tracks was 99. In comparative example 1, the tracks of the abrasive grain were shaped as shown in FIG. 5A, and the number of intersections between tracks was 0. In both example 1 and comparative example 1, conditions, such as the oscillation stroke, the material of the tape member, the hardness of the roller, and the load applied to the pair of rollers, were all the same.

Regarding the glass substrates of example 1 and comparative example 1, NRa prior to texture formation and NRa subsequent to texture formation were measured in addition to BR and BH. The results are shown in table 1 and the graph of FIG. 8.

TABLE 1

| | | | | NRa before | NRa after |
|---|---|---|---|---|---|
| | Oscillation | Rotation | | texture | texture |
| | frequency | speed | Intersection | formation | formation |
| | F (Hz) | R (min⁻¹) | (number) | (nm) | (nm) |
| Ex. 1 | 4.50 | 240 | 99 | 0.14 | 0.15 |
| Comp. | 4.00 | 240 | 0 | 0.15 | 0.21 |
| Ex. 1 | | | | | |

From the results of table 1, in comparative example 1, the NRa after texture formation worsened by 0.06 nm from the NRa before texture formation, and the NRa after texture formation exceeded 0.2 nm. In example 1, the difference of NRa before and after texture formation was only 0.01 nm, and the NRa after texture formation was 0.15 nm and was thus 0.2 nm or less.

From the graph of FIG. 8, in comparative example 1, BH was entirely high. Further, it is apparent that BH varied especially when BR was 0.4 to 0.1%. This indicated that the height of the ridges varied within the measurement region. In example 1, BH was proportional to BR and the line of the graph was substantially linear. This indicated that the texture (height of the ridges) was even and that burrs were not formed.

Consequently, compared to comparative example 1 in which the tracks did not intersect, in example 1 in which the tracks of the abrasive grain intersected, the NRa was satisfactorily maintained even after texture formation. Further, from BH and BR, the texture formed was such in which the height of the ridges was the same and burrs were not present.

### EXAMPLES 2 TO 5 AND COMPARATIVE EXAMPLES 2 TO 9

Similar to example 1 and comparative example 1, the glass substrates of examples 2 to 5 and comparative examples 2 to 9 were manufactured under the processing conditions shown in table 2. In examples 2 to 5, the tracks of the abrasive grains were shaped as shown in FIG. 4B, and the number of intersections between the tracks was 99. In comparative examples 2 to 5, the tracks of the abrasive grain were shaped as shown in FIG. 5A, and the number of intersections was 0. In comparative examples 6 to 9, the tracks of the abrasive grain were shaped as shown in FIG. 6B, and the number of intersections was 2.

TABLE 2

| | Oscillation | Rotation | Hardness | Pressing |
|---|---|---|---|---|
| | frequency | speed | of Roller | Force |
| | F(Hz) | R(min⁻¹) | (duro) | (N) |
| Example 2 | 4.50 | 240 | 40 | 40.0 |
| Example 3 | 4.50 | 240 | 90 | 40.0 |
| Example 4 | 4.50 | 240 | 40 | 26.7 |
| Example 5 | 4.50 | 240 | 90 | 26.7 |
| Comp Ex. 2 | 0 | 240 | 40 | 40.0 |
| Comp Ex. 3 | 0 | 240 | 90 | 40.0 |
| Comp Ex. 4 | 0 | 240 | 40 | 26.7 |
| Comp Ex. 5 | 0 | 240 | 90 | 26.7 |
| Comp Ex. 6 | 3.95 | 240 | 40 | 40.0 |
| Comp Ex. 7 | 3.95 | 240 | 90 | 40.0 |
| Comp Ex. 8 | 3.95 | 240 | 40 | 26.7 |
| Comp Ex. 9 | 3.95 | 240 | 90 | 26.7 |

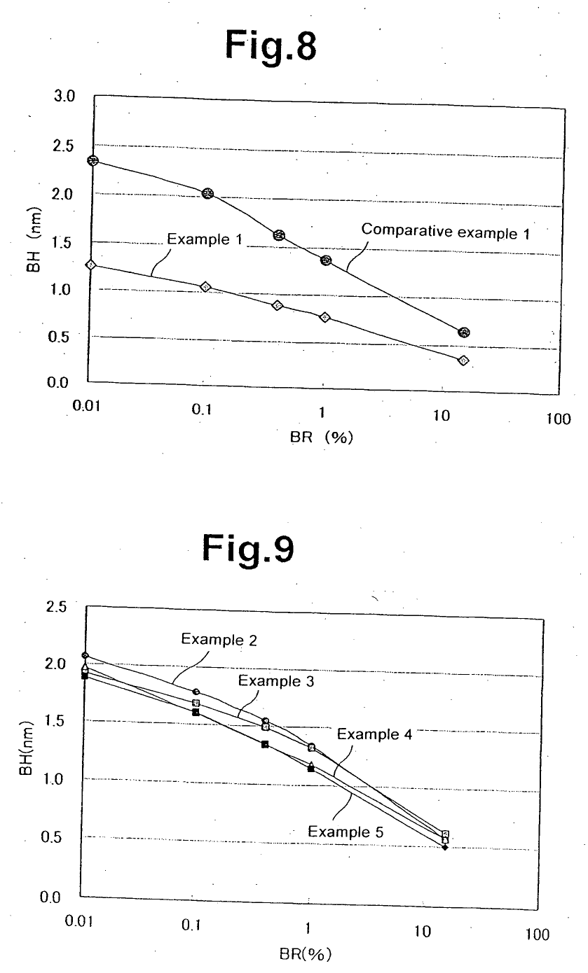

BR and BH were measured for the glass substrates of examples 2 to 5 and comparative examples 2 to 9. The results are shown in the graphs of FIG. 9 to FIG. 11.

It is apparent from the graph of FIG. 9 that even though the glass substrates of examples 2 to 5 were different, a great difference was not found in BH. Further, the texture formed was such that the height was evenly aligned and in which burrs were not present.

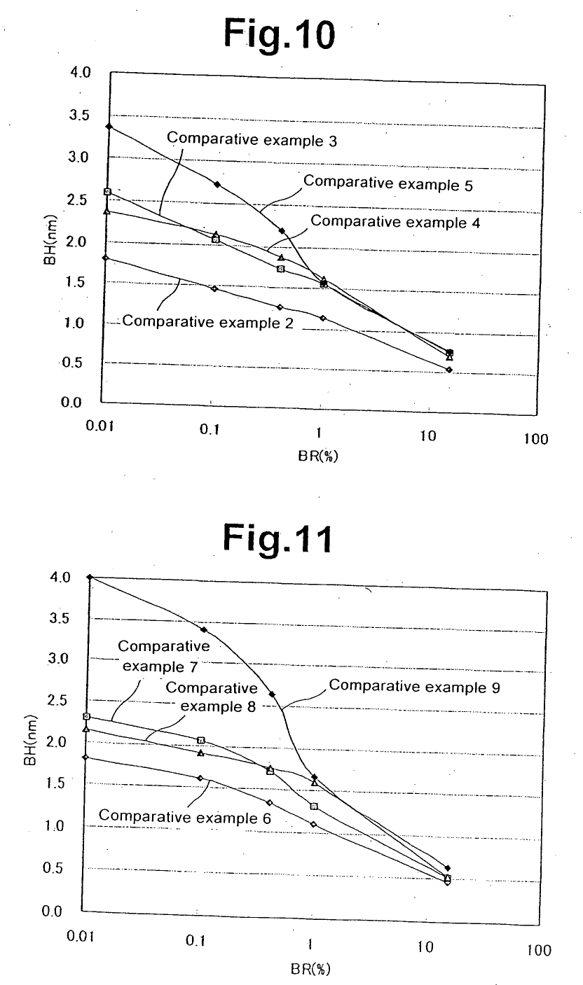

It is apparent that from the graph of FIG. 10, the glass substrates of comparative examples 2 to 5 had a great difference in BH. Among them, in comparative example 5, the line drawn in the graph was greatly deviated from the straight line indicating that the shape of the texture varied greatly. This is thought to be due to, as mentioned above, the fact that in the track having no intersections, if the abrasive grain moved so as to scrape the same location a number of times, the surface condition of the glass substrate deteriorated accordingly. However, comparative example 2 showed a satisfactory result suggesting that if the abrasive grain moved to correct the defects, the surface condition may become satisfactory.

From the graph of FIG. 11, the glass substrates of comparative examples 6 to 9 each had a great difference in BH, and the lines drawn in the graph changed greatly thus suggesting that the shape of the texture also greatly varied. This is due to, as mentioned above, the fact that in tracks having two intersections, the abrasive grain moved so as to scrape the same location a number of times at the intersections, and the surface condition of the glass substrate deteriorated accordingly. Particularly, comparative example 9 showed significant deterioration of the surface condition.

Consequently, compared to when tracks do not intersect, by intersecting the tracks, the texture was formed on the glass substrate while stably maintaining the surface condition. Further, glass substrates having a satisfactory surface condition was obtained with stable yield.

The above mentioned embodiments may be modified in the following manner.

To satisfy the required impact-resistance, oscillation-resistance, and heat-resistance for the information recording medium, a chemical strengthening process may be performed on the glass substrate in a step before the texture processing step. The chemical strengthening process is a process for ion converting a monovalent metal ion such as a lithium ion and a sodium ion contained in the composition of the glass substrate to a monovalent metal ion such as sodium ion and potassium ion having a greater ionic radius. The chemical strengthening method applies compression stress on the main surface of the glass substrate to chemically strengthen the glass substrate. The chemical strengthening method is performed by immersing a glass substrate into a chemical strengthening process fluid in which a chemical strengthening salt is heated and dissolved over a predetermined time. Examples of chemical strengthening salts include potassium nitrate, sodium nitrate, silver nitrate, or a mixture of at least two of the above materials. The temperature of the chemical strengthening fluid is preferably lower than the strain point of the material used in the glass substrate by about 50 to 150° C., and more preferably, the temperature of the chemical strengthening process fluid itself is about 300 to 450° C. At a temperature lower than the strain point of the material of the glass substrate by about 150° C., the chemical strengthening process cannot be sufficiently performed on the glass substrate. If the temperature exceeds the temperature lower than the strain point of the material of the glass substrate by 50° C., distortion may be produced in the glass substrate when undergoing the chemical strengthening process.

In the above embodiments, the roller 31 is oscillated, but the present invention is not limited to such action and the glass plate 11a may be oscillated instead. That is, the glass plate 11a is rotated and oscillated in the radial direction with respect to the roller 31.

1. A method for manufacturing a glass substrate for an information recording medium, the method comprising:
forming a texture on a main surface of a disc-shaped glass plate by supplying an abrasive agent containing an abrasive grain to the main surface and slidably contacting the main surface with an abrasive member; and
oscillating either one of the abrasive member and the glass plate in a radial direction of the glass plate with respect to the other one of the abrasive member and the glass plate while rotating the glass plate so that the abrasive grain repeatedly draws a closed track that intersects in at least three locations on the main surface of the glass plate.

2. The manufacturing method according to claim 1, wherein a frequency F in Hertz of the oscillation and a rotation speed R in revolutions per minute of the glass plate are determined so that the rotation speed R is outside a range of (F×60)±5.

3. The manufacturing method according to claim 1, wherein the closed track includes at least five intersections.

4. The manufacturing method according to claim 1, wherein the frequency of oscillation is greater than 0 Hz but 20 Hz or less.

5. The manufacturing method according to any one of claim 1, wherein the rotation speed is 240 to 540 revolutions per minute.

6. The manufacturing method according to claim 1, wherein the oscillation has a stroke of 0.5 to 2 mm.

7. The manufacturing method according to claim to, wherein the abrasive member is a roller made of an elastic material having a duro hardness, as defined by ISO 7627-2, of 40 to 90.

8. The manufacturing method according to claim 1, further comprising:
scrubbing the main surface of the glass plate with a scrubbing material in which a 100% modulus, as defined by JIS K7113, is 2.9 to 39.2 MPa after said forming a texture.

9. The manufacturing method according to claim 4, wherein the frequency of oscillation is greater than 0 Hz but 4 Hz or less when an outer diameter of the glass plate is 48 mm or less, and the frequency of oscillation is greater than 4 Hz but 20 Hz or less when the outer diameter is greater than 48 mm.

10. A method for manufacturing a glass substrate for an information recording medium, the method by comprising the steps of:
preparing a disc-shaped glass plate having a main surface and a central circular hole; and
forming on the main surface a texture including a plurality of grooves, each extending along a closed curve that intersects in at least three locations around the central circular hole.

11. The manufacturing method according to claim 10, wherein the step for forming a texture includes:
supplying an abrasive agent containing an abrasive grain to the main surface of the glass plate;
pressing an abrasive member against the main surface of the glass plate;
cyclically oscillating either one of the glass plate or the abrasive member in the radial direction of the glass plate; and
rotating the glass plate at a constant speed.

12. The manufacturing method according to claim 11, wherein the step for forming a texture includes determining the rotation speed, frequency of oscillation, and stroke of oscillation of the glass plate.

13. The manufacturing method according to claim 12, wherein the stroke of oscillation is 0.5 to 2 mm, and the frequency F in Hertz of oscillation and the rotation speed R in revolutions per minute of the glass plate are determined so that the rotation speed R is outside the range of (F×60)±5.

14. The method of manufacturing according to claim 13, wherein the frequency of oscillation is changed in accordance with an outer diameter dimension of the glass plate.

15. A glass substrate for an information recording medium the glass substrate comprising a main surface on which a texture is formed, the main surface having an arithmetic mean roughness Ra, as measured by an atomic force microscope, of 0.5 nm or less, and the main surface has having a microscopic undulation height NRa of 0.2 nm or less, as measured by a three-dimensional surface structure analyzing microscope using light having a measuring wavelength of 0.2 to 1.4 mm.

16. The glass substrate according to claim 15, wherein:
the texture includs a plurality of projections; and in a region having a predetermined reference area in the main surface, when setting a hypothetical reference plane traversing the plurality of projections so that a total value of a cross sectional area of the plurality of projections is 50% relative to the reference area,
a first hypothetical plane parallel to the main surface and traversing the plurality of projections so that the total value of the cross sectional area of the plurality of projections is 0.4% relative to the reference area is separated from the hypothetical reference plane by a first distance,
a second hypothetical plane parallel to the main surface and traversing the plurality of projection so that the total value of the cross sectional area of the plurality of projections is 0.01% relative to the reference area is separated from the hypothetical reference plane by a second distance, and
the difference between the first distance and the second distance is 0.01 to 1.0 nm.

17. A disc-shaped glass substrate for an information recording medium, the disc-shaped glass substrate comprising: a main surface having a central circular hole, and a texture including a plurality of grooves, each extending along a closed curve that intersects in at least three locations around the central circular hole, formed on the main surface.

18. The manufacturing method according to claim 1, wherein said closed track forms intersections therein and the intersections are equally distributed on the main surface of the glass plate.
